(19) United States
(12) Patent Application Publication
(10) Pub. No.: US 2010/0036799 A1
(43) Pub. Date: Feb. 11, 2010

(54) QUERY PROCESSING USING HORIZONTAL PARTIAL COVERING JOIN INDEX

(75) Inventors: Carlos Bouloy, San Diego, CA (US); Grace Au, Rancho Palos Verdes, CA (US); Hong Gui, Middleton, WI (US)

Correspondence Address: JAMES M. STOVER;TERADATA CORPORATION, 2835 MIAMI VILLAGE DRIVE, MIAMISBURG, OH, 45342, US

(73) Assignee: Teradata US, Inc., Miamisburg, OH (US)

(21) Appl. No.: 12/186,173

(22) Filed: Aug. 5, 2008

(51) Int. Cl. G06F 17/30

(52) U.S. Cl. 707/2; 707/E17.131

(57) ABSTRACT

A computer implemented system and method includes obtaining a query referring to rows in a relational database. A sparse index of the database that has a set of rows that is a subset of the rows referred to in the query is obtained. Rows referred to in the query that are not in the sparse index are then obtained and a union of such rows and the rows of the sparse index is performed to obtain a complete row set for processing the query.

### RELATED APPLICATIONS

This application is related to the following application filed on the same date herewith: Deferred Maintenance of Sparse Join Indexes (Applicant Reference Number: 2704.007US1).

### BACKGROUND

A relational database stores data that is logically related by rows and columns. The database may be queried for data such as by using a query language to identify the data desired, and where in the database to look for the data. A query optimizer may take the query and determine if there is a more efficient way to process the query. Some databases facilitate the creation of indexes, which may be thought of as a subset of the database that contains data that is organized in a certain manner, and may contain further data that is aggregated, or pre-calculated. Currently, when a join index is used to rewrite a query, the join index contains the same set or a super set of rows that is used to process the query. If the join index does not contain all the rows needed to process the query, it is not used.

### BRIEF DESCRIPTION OF THE DRAWINGS

FIG. 1 is a block diagram of a hardware an software environment for implementing methods according to an example embodiment.

FIG. 2 is a flowchart illustrating a method of obtaining a complete row set for a query according to an example embodiment.

FIG. 3 is a flowchart illustrating a method of rewriting a query to provide query results according to an example embodiment.

FIG. 4 illustrates a join index time line that partially covers a query range according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or methods described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A join index with single table predicates is known as “sparse join index”. The predicate is called sparse condition, which filters out rows that are not needed in the join index. A “snapshot join index” may be defined with a sparse condition that confines the data set included in the join index. A sparse join index may be used to answer queries on bigger data sets by fetching the missing rows of the sparse join index from a base table. In various embodiments, faster response time to queries may be obtained by leveraging pre-aggregated, pre-joined data contained within such horizontal partial covering join indexes. A join index may be used in processing a query when the join index is sparse. A sparse join index contains a subset of rows that will be used in processing the query. A “snapshot join index” may be defined with a sparse condition that confines the data set included in the join index. A sparse join index may be used to answer queries on bigger data sets by fetching the missing rows of the sparse join index from a base table. In various embodiments, faster response time to queries may be obtained by leveraging pre-aggregated, pre-joined data contained within sparse join indexes.

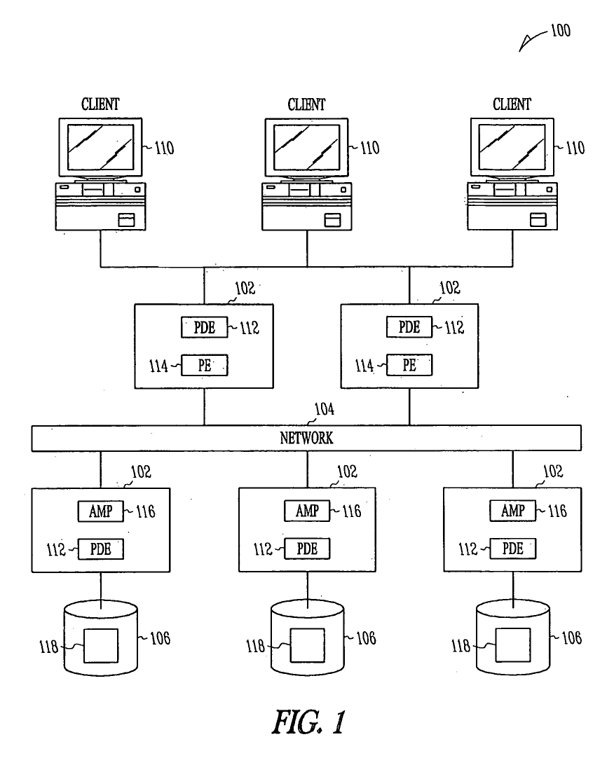

FIG. 1 illustrates an example hardware and software environment that may be used to implement the partial covering methods. A computer system 100 may be comprised of one or more processing units (PUs) 102, also known as processors or nodes, which may be interconnected by a network 104. Each of the PUs 102 may be coupled to zero or more fixed and/or removable data storage units (DSUs) 106, such as disk drives, that store one or more relational databases. Further, each of the PUs 102 may be coupled to zero or more data communications units (DCUs) 108, such as network interfaces, that communicate with one or more remote systems or devices.

Operators of the computer system 100 typically use a workstation 110, terminal, computer, handheld wireless device or other input device to interact with the computer system 100. This interaction generally comprises queries that conform to a Structured Query Language (SQL) standard, and invoke functions performed by a Relational Database Management System (RDBMS) executed by the system 100. In further embodiments, the computer system 100 may implement on-line analysis processing (OLAP) or multidimensional OLAP (MOLAP) or relational OLAP (ROLAP). Various other processing systems may also be implemented by computer system 100 or other computer systems capable of providing access to relational databases.

In one embodiment, the RDBMS comprises the Teradata.® product offered by Teradata US, Inc., and may include one or more Parallel Database Extensions (PDEs) 112, Parsing Engines (PEs) 114, and Access Module Processors (AMPs) 116. These components of the RDBMS perform the function which enable of RDBMS and SQL standards, i.e., definition, compilation, interpretation, optimization, database access control, database retrieval, and database update.

Work may be divided among the PUs 102 in the system 100 by spreading the storage of a partitioned relational database 118 managed by the RDBMS across multiple AMPs 116 and the DSUs 106 (which are managed by the AMPs 116). Thus, a DSU 106 may store only a subset of rows that comprise a table in the partitioned database 118 and work is managed by the system 100 so that the task of operating on each subset of rows is performed by the AMP 116 managing the DSUs 106 that store the subset of rows.

The PEs 114 handle communications, session control, optimization and query plan generation and control. The PEs 114 fully parallelize all functions among the AMPs 116. As a result, the system of FIG. 1 applies a multiple instruction stream, multiple data stream (MIMD) concurrent processing architecture to implement a relational database management system 100.

Both the PEs 114 and AMPs 116 are known as “virtual processors” or “vprocs”. The vproc concept is accomplished by executing multiple threads or processes in a PU 102, wherein each thread or process is encapsulated within a vproc. The vproc concept adds a level of abstraction between the multi-threading of a work unit and the physical layout of the parallel processing computer system 100. Moreover, when a PU 102 itself is comprised of a plurality of processors or nodes, the vproc concept provides for intra-node as well as the inter-node parallelism.

The vproc concept results in better system 100 availability without undue programming overhead. The vprocs also provide a degree of location transparency, in that vprocs communicate with each other using addresses that are vproc-specific, rather than node-specific. Further, vprocs facilitate redundancy by providing a level of isolation/abstraction between the physical node 102 and the thread or process. The result is increased system 100 utilization and fault tolerance.

In various embodiments, data partitioning and repartitioning may be performed, in order to enhance parallel processing across multiple AMPs 116. For example, the data may be hash partitioned, range partitioned, or not partitioned at all (i.e., locally processed). Hash partitioning is a partitioning scheme in which a predefined hash function and map is used to assign records to AMPs 116, wherein the hashing function generates a hash “bucket” number and the hash bucket numbers are mapped to AMPs 116. Range partitioning is a partitioning scheme in which each AMP 116 manages the records falling within a range of values, wherein the entire data set is divided into as many ranges as there are AMPs 116. No partitioning means that a single AMP 116 manages all of the records.

Generally, the PDEs 112, PEs 114, and AMPs 116 are tangibly embodied in and/or accessible from a device, media, carrier, or signal, such as RAM, ROM, one or more of the DSUs 106, and/or a remote system or device communicating with the computer system 100 via one or more of the DCUs 108. The PDEs 112, PEs 114, and AMPs 116 each comprise logic and/or data which, when executed, invoked, and/or interpreted by the PUs 102 of the computer system 100, cause the methods or elements of the present invention to be performed.

As noted above, many different hardware and software environments may be used to implement the methods described herein. A spectrum of embodiments ranging from stand alone processors with a single storage device, to multiple distributed processors with distributed storage devices storing one or more databases may be used in various embodiments.

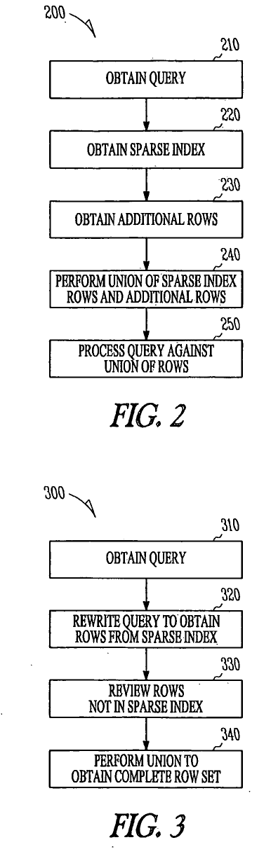

In FIG. 2, a computer implemented method 200 includes obtaining a query referring to rows in a relational database at 210. A sparse index of the database that has a set of rows that is a subset of the rows referred to in the query is obtained at 220. At 230, rows referred to in the query that are not in the sparse index are obtained. A union of such rows and the rows of the sparse index is performed at 240 to obtain a complete row set for processing the query. In one embodiment, the query may be processed against the union of rows at 250.

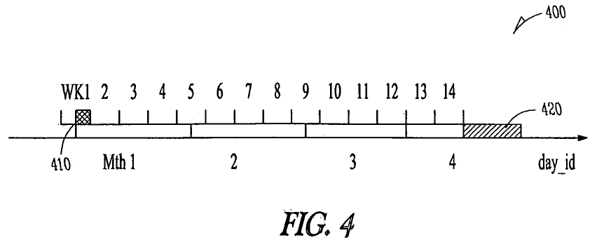

In a further embodiment as illustrated in FIG. 3, a computer implemented method 300 is performed to rewrite a query to provide query results in a more efficient manner. The query is first obtained at 310 and refers to rows in a relational database. At 320, the query is rewritten to select rows from a sparse index. At 330, rows that are not in the sparse index are retrieved and at 340 a union of such rows and the rows of the sparse index is performed to obtain a complete row set for processing the query.

In one example embodiment, base tables are defined with a partitioned primary index (PPI) by which new incoming data go to the most recent partition(s) as described in the following database definition language (DDL) statements:

```
CREATE SET TABLE orders
  (
  o_orderkey INTEGER NOT NULL,
  o_orderdate DATE FORMAT ‘yyyy-mm-dd’ NOT NULL,
  o_amount integer)
PRIMARY INDEX ( o_orderkey )
PARTITION BY RANGE_N(o_orderdate BETWEEN DATE
‘1998-01-01’ AND DATE ‘2004-12-31’ EACH INTERVAL ‘1’
MONTH );
```

The last two lines correspond to a very specific example. In further embodiments, the statements may be represented generically as:

PARTITION BY RANGE_N(o_orderdate BETWEEN DATE ‘xxx’
AND DATE ‘yyy’ EACH INTERVAL ‘zzz’ QQQ )

wherein xxx and yyy are dates, and zzz is a number of time periods QQQ. As indicated above, the dates are in one specific format, but may be in other formats as desired. While a MONTH is indicated as the time period above, the time period may be varied to correspond to an actual application, such as a day, week, year, quarter, hour, minute, or whatever other type of time period desired.

A join index may be defined with the sparse condition that specifies a “snapshot view” of the data. When the base table is updated, the join index (JI) maintenance may be bypassed as a result of the values of the updated rows being outside the range set by the sparse condition.

CREATE JOIN INDEX orders_ji AS
SEL o_orderkey, o_orderdate, o_amount
FROM orders
WHERE o_orderdate BETWEEN DATE ‘2003-01-01’ AND
DATE ‘2004-10-31’
PRIMARY INDEX (o_orderkey)
PARTITION BY range_n(o_orderdate BETWEEN DATE ‘1998-01-01’
AND DATE ‘2004-10-31’ EACH INTERVAL ‘1’ MONTH );
EXPLAIN INS INTO orders (100, ‘2004-11-01’, 1000);

1) First, perform an INSERT into HONG.orders.

->No rows are returned to the user as the result of statement 1.

EXPLAIN DEL orders WHERE o_orderdate<‘2003-01-01’;
1) First, lock a distinct HONG.“pseudo table” for write on a RowHash to prevent global deadlock for HONG.orders.
2) Next, lock HONG.orders for write.
3) Perform an all-AMPs DELETE from 60 partitions of HONG.orders with a condition of (“HONG.orders.o_orderdate<DATE ‘2003-01-01’”).
4) Finally, send out an END TRANSACTION step to all AMPs involved in processing the request.

No rows are returned to the user as the result of statement 1.

This “snapshot ji” can be used to answer queries that ask for more rows than those included in the JI. For example, the following query

```
  SEL *
  FROM orders
  WHERE o_orderdate BETWEEN DATE ‘2002-01-01’ AND DATE
‘2004-12-31’;
can be rewritten as:
  SEL *
  FROM
  (SEL *
  FROM orders_ji
  WHERE ji_ret_cond
  UNION ALL
  SEL *
  FROM orders
  WHERE base_ret_cond)DT;
```

Assume that the sparse condition in the JI definition and the query condition are sparse_ji_Cond and query_cond, respectively. The ji_ret_cond, which represents the condition used for the join index retrieval, is calculated as:

ji_ret_cond=query_cond AND sparse_ji_cond

Since all the rows in the join index already satisfy the sparse_ji_cond, the expression can be simplified as:

ji_ret_cond=query_cond

Furthermore, when

!query_cond AND sparse_ji_cond=false;
i.e. the row set of the query result is a superset of the row set included in the join index, ji_ret_cond may be set to be true because all the rows in the join index are needed to answer the query. In the above example,

```
query_cond = o_orderdate BETWEEN DATE ‘2002-01-01’ AND
DATE ‘2004-12-31’;
sparse_ji_cond = o_orderdate BETWEEN DATE ‘2003-01-01’ AND
DATE ‘2004-10-31’;
Since
!query_cond AND sparse_ji_cond
= (o_orderdate < ‘2002-01-01’ OR o_orderdate > ‘2004-12-31’) AND
  (o_orderdate >= ‘2003-01-01’ AND o_orderdate <= ‘2004-10-31’)
= (o_orderdate < ‘2002-01-01’ AND o_orderdate >= ‘2003-01-01’ AND
  o_orderdate <= ‘2004-10-31’) OR
  (o_orderdate > ‘2004-12-31’ AND o_orderdate >= ‘2003-01-01’ AND
  o_orderdate <= ‘2004-10-31’)
= false
```

Therefore, ji_ret_cond=true in this example.

The base_ret_cond, which represents the condition for the retrieval from the base table to get the extra rows needed in the query, is calculated as:

```
base_ret_cond = query_cond AND !sparse_ji_cond
Since
query_cond AND !sparse_ji_cond
= (o_orderdate >= ‘2002-01-01’ AND o_orderdate <= ‘2004-12-31’)
  AND (o_orderdate < ‘2003-01-01’ OR o_orderdate > ‘2004-10-31’)
= (o_orderdate >= ‘2002-01-01’ AND o_orderdate <= ‘2004-12-31’
  AND o_orderdate < ‘2003-01-01’) OR
  (o_orderdate >= ‘2002-01-01’ AND o_orderdate <= ‘2004-12-31’
  AND o_orderdate > ‘2004-10-31’)
= (o_orderdate >= ‘2002-01-01’ AND o_orderdate < ‘2003-01-01’) OR
  (o_orderdate > ‘2004-10-31’ AND o_orderdate <= ‘2004-12-31’)
```

Therefore base_ret_cond specifies two range conditions that correspond to the rows that are required in the query but are not included in the join index.

The above example illustrates the idea of the “horizontal partial covering”—when the row set in JI is a subset of that required by the query, a retrieval to the base table for the rest of rows is needed and the union of the two can give the row set required in the query.

In the following, an example is described where using the horizontal partial covering method can help to improve performance by leveraging an aggregate join index (AJI) with aggregates at the same or lower level than that is required in the query. Assume a fact table and a dimension table as:

Sales (store_id, day_id, prod_id, amount);
Calendar (day_id, wk, mth, qtr, yr) unique index(day_id);

An AJI at week level is defined as:

CREATE JOIN INDEX AJI_wk AS
SEL wk, mth, SUM(amount) AS wktotalsales
FROM sales, calendar
WHERE sales.day_id = calender.day_id AND

wk BETWEEN startweek AND endweek

GROUP BY wk, mth
PRIMARY INDEX (wk)
PARTITION BY RANGE_N(wk BETWEEN startweek
AND endweek EACH INTERVAL ‘1’ WEEK);

A query that rolls up to the month level,

SEL mth, SUM(amount)
FROM sales, calendar
WHERE sales.day_id = calender.day_id AND mth
BETWEEN startmonth AND endmonth;
can be answered by the following rewritten query:
SEL mth, SUM (mthtotalsales)
FROM

(SEL mth, SUM(wktotalsales) AS mthtotalsales
FROM AJI_wk
WHERE mth BETWEEN startmonth AND endmonth
GROUP BY mth
UNION ALL
SEL mth, SUM(amount) AS mthtotalsales
FROM sales, calendar
WHERE sales.day_id = calender.day_id and

(mth >= startmonth and mth <= endmonth and wk < startweek)
OR
(mth >= startmonth and mth <= endmonth and wk > endweek)

GROUsP BY mth) DT (month, mthtotalsales)

GROUP BY mth;

The time ranges covered in the join index (from startweek to endweek) and in the query (from startmonth to endmonth) may be different. So going back to the base table to get the missing rows in the join index may be needed in order to use the AJI to answer the query. A time line 400 in FIG. 4 illustrates that the join index time line covers the query range on the left side but falls short on the right. A portion of data in the first week that are in the startmonth are indicated at 410. Rows that are not included in the join index but required in the query are indicated at 420. By adding the query condition to the join index retrieval, the portion of data in the 1^{st} week corresponding to the startmonth in the query is selected. This can be done because mth is included in the join index's grouping key. On the other hand, those rows that satisfy the base_ret_cond are fetched from the Calendar table, joined with the Sales table and rolled up to the month level. Note that a final SUM step is added on top of the UNION. The final SUM step is used because there can be overlapping rows returned from the two retrievals. For example, in the time line shown in the diagram, both the roll-ups from the 13^{th} and 14^{th} week in the join index and the rows fetched from the base table correspond to the endmonth. One final aggregate is added to merge the subtotals for the same grouping key.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A computer implemented method comprising:
obtaining a query referring to rows in a relational database;
obtaining a sparse index of the database that has a set of rows that is a subset of the rows referred to in the query;
obtaining the rows referred to in the query that are not in the sparse index; and
performing a union of such rows and the rows of the sparse index to obtain a complete row set for processing the query.

2. The method of claim 1 and further comprising processing the query against the complete row set.

3. The method of claim 1 wherein obtaining a sparse index comprises defining base tables with a partitioned primary index.

4. The method of claim 3 wherein new incoming data is stored in most recent partitions.

5. The method of claim 3 wherein the base tables are defined with data definition language statements comprising:
```
CREATE SET TABLE orders
  (
  o_orderkey INTEGER NOT NULL,
  o_orderdate DATE FORMAT ‘yyyy-mm-dd’ NOT NULL,
  o_amount integer)
PRIMARY INDEX ( o_orderkey )
PARTITION BY RANGE_N(o_orderdate BETWEEN DATE ‘xxx’
AND DATE ‘yyy’ EACH INTERVAL ‘zzz’ QQQ )
wherein xxx and yyy are dates, and zzz is a number of time periods QQQ.
```

6. The method of claim 1 and further comprising leveraging an aggregate join index (AJI) with aggregates at a same or lower level than in a query.

7. The method of claim 1 wherein rows referred to in the query that are not in the sparse index are obtained from a base table.

8. The method of claim 7 and further comprising rewriting the received query utilizing the sparse index, rows from the base table and union of the sparse index and rows from the base table.

9. The method of claim 8 and further comprising a sum following the union to deal with overlapping rows returned from the sparse index and rows from the base table.

10. A computer implemented method comprising:
obtaining a query referring to rows in a relational database;
rewriting the query to select rows from a sparse index, obtain rows that are not in the sparse index and perform a union of such rows and the rows of the sparse index to obtain a complete row set for processing the query.

11. The method of claim 10 wherein the sparse index is defined from base tables with a partitioned primary index.

12. The method of claim 11 wherein the base tables are defined with data definition language statements comprising:
```
CREATE SET TABLE orders
  (
  o_orderkey INTEGER NOT NULL,
  o_orderdate DATE FORMAT ‘yyyy-mm-dd’ NOT NULL,
  o_amount integer)
PRIMARY INDEX ( o_orderkey )
PARTITION BY RANGE_N(o_orderdate BETWEEN DATE ‘xxx’
AND DATE ‘yyy’ EACH INTERVAL ‘zzz’ QQQ )
wherein xxx and yyy are dates, and zzz is a number of time periods QQQ.
```

13. The method of claim 10 and wherein the query is rewritten to leverage an aggregate join index (AJI) with aggregates at a same or lower level than in the query.

14. The method of claim 10 wherein rows referred to in the query that are not in the sparse index are obtained from a base table.

15. A computer readable medium having instructions for execution by a computer to perform a method comprising:
obtaining a query referring to rows in a relational database;
obtaining a sparse index of the database that has a set of rows that is a subset of the rows referred to in the query;
obtaining the rows referred to in the query that are not in the sparse index; and
performing a union of such rows and the rows of the sparse index to obtain a complete row set for processing the query.

16. The computer readable medium of claim 15 wherein the method further comprises performing a sum following the union to deal with overlapping rows returned from the sparse index and rows from the base table.

17. A system comprising:
one or more processing units;
one or more data storage units coupled to the one or more processors;
one or more optimizers executing on the one or more processing units that are configured to:
obtain a query referring to rows in a relational database;
obtain a sparse index of the database that has a set of rows that is a subset of the rows referred to in the query;
obtain the rows referred to in the query that are not in the sparse index; and
perform a union of such rows and the rows of the sparse index to obtain a complete row set for processing the query.

18. The system of claim 17 wherein the one or more processors process the query against the complete row set.

19. The system of claim 17 wherein an aggregate join index (AJI) with aggregates at a same or lower level than in a query is leveraged.

20. The system of claim 17 wherein the query optimizer rewrites the received query utilizing the sparse index, rows from the base table and union of the sparse index and rows from the base table.
